(19) United States
(12) Patent Application Publication
(10) Pub. No.: US 2020/0104901 A1
(43) Pub. Date: Apr. 2, 2020

(54) INFORMATION PROCESSING APPARATUS

(71) Applicant: FUJI XEROX CO., LTD., Tokyo (JP)

(72) Inventors: Tomoko OKUMA, Kanagawa (JP); Masahiro SATO, Kanagawa (JP); Tomoki TANIGUCHI, Kanagawa (JP)

(73) Assignee: FUJI XEROX CO., LTD., Tokyo (JP)

(21) Appl. No.: 16/386,346

(22) Filed: Apr. 17, 2019

(30) Foreign Application Priority Data
Oct. 2, 2018 (JP) 2018-187513

(51) Int. Cl. G06Q 30/06; G06Q 30/02; G06Q 50/00

(52) U.S. Cl. CPC G06Q 30/0631; G06Q 50/01; G06Q 30/0255

(57) ABSTRACT

An information processing apparatus includes an attribute estimating unit, a preference estimating unit, a storage unit, a specifying unit, and a presentation unit. The attribute estimating unit estimates, from posting histories of multiple users, an attribute of each of the users. The preference estimating unit estimates, from the posting histories of the users, preference of each of the users. The storage unit stores the estimated attribute and preference in association with each other. The specifying unit specifies the preference corresponding to an attribute of a user who is to be a recommendation target. The preference is specified from information stored in the storage unit. The presentation unit presents, to the user who is to be a recommendation target, an item in accordance with the preference specified for the user who is to be a recommendation target.

### CROSS-REFERENCE TO RELATED APPLICATIONS

This application is based on and claims priority under 35 USC 119 from Japanese Patent Application No. 2018-187513 filed Oct. 2, 2018.

### BACKGROUND

### (i) Technical Field

The present disclosure relates to an information processing apparatus.

### (ii) Related Art

There is a mechanism of recommending products and services (hereinafter collectively referred to as items). For example, according to Japanese Unexamined Patent Application Publication No. 2014-67359, a mechanism of recommending a product on the basis of the reputation of the product in a social networking service (SNS) has been proposed.

### SUMMARY

Aspects of non-limiting embodiments of the present disclosure relate to a technique of presenting an item in accordance with the preference of a certain user even when information for estimating the preference of the certain user is insufficient.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including an attribute estimating unit, a preference estimating unit, a storage unit, a specifying unit, and a presentation unit. The attribute estimating unit estimates, from posting histories of multiple users, an attribute of each of the users. The preference estimating unit estimates, from the posting histories of the users, preference of each of the users. The storage unit stores the estimated attribute and preference in association with each other. The specifying unit specifies the preference corresponding to an attribute of a user who is to be a recommendation target. The preference is specified from information stored in the storage unit. The presentation unit presents, to the user who is to be a recommendation target, an item in accordance with the preference specified for the user who is to be a recommendation target.

### BRIEF DESCRIPTION OF THE DRAWINGS

Exemplary embodiment of the present disclosure will be described in detail based on the following figures, wherein:

FIG. 1 is a block diagram illustrating the configuration of an information processing system according to an exemplary embodiment of the present disclosures 2 is a block diagram illustrating the hardware configuration of an information processing apparatus;

FIG. 3 is a block diagram illustrating the functional configuration of an information processing apparatus; and

FIG. 4 is a flowchart of operations performed by an information processing apparatus.

### DETAILED DESCRIPTION

### Configuration

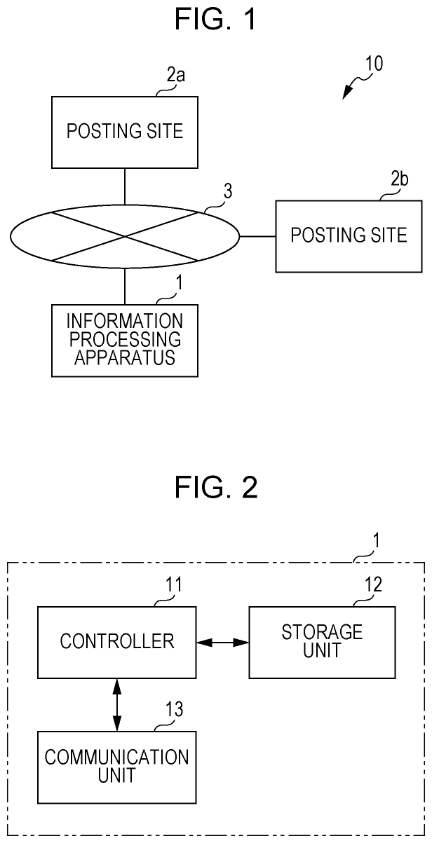

An exemplary embodiment of the present disclosure will be described below. FIG. 1 is a block diagram illustrating the configuration of an information processing system 10 according to the exemplary embodiment of the present disclosure. The information processing system 13 includes an information processing apparatus 1, posting sites 2a and 2b (hereinafter referred to as posting sites 2), and a network 3 such as the Internet which communicatively connects these to one another. The posting sites 2 are computers, for example, which provide services called a social networking service (SNS), a blog, and a bulletin board. The posting sites 2 accumulate data posted by users (hereinafter referred to as SNS users) who use SNSs (hereinafter, the data is referred to as posting histories), and provides the data to apparatuses connected to the network 3. The information processing apparatus 1 estimates, from each posting history accumulated in the posting sites 2, the attribute of an SNS user, such as their age and gender, and the degree of the preference of the SNS user for an item. Then, the information processing apparatus 1 specifies the relationship between attribute and the degree of preference. The information processing apparatus 1 uses the relationships to specify, from the attribute of a target user (hereinafter referred to as a customer-user) to whom a recommendation is given (hereinafter referred to as a recommendation target), an item that is to be recommended the customer-user. Then, the information processing apparatus 1 presents information about the item to the customer-user.

FIG. 2 is a block diagram illustrating the hardware configuration of the information processing apparatus 1. The information processing apparatus 1 includes a controller 11, a communication unit 13, and a storage unit 12. The controller 11 includes an arithmetic processing unit such as a central processing unit (CPU) and storage devices, such a a read only memory (ROM) and a random access memory (RAM). The ROM is used to store programs performed by the CPU. The CPU uses the RAM as a work area to execute programs stored in the ROM and the storage unit 12. Thus, the CPU controls the operations of the units of the information. processing apparatus 1. The communication unit 13 includes a communication line, and performs data communication. The storage unit 12 is a storage unit such as a hard disk, and stores data and programs used by the controller 11.

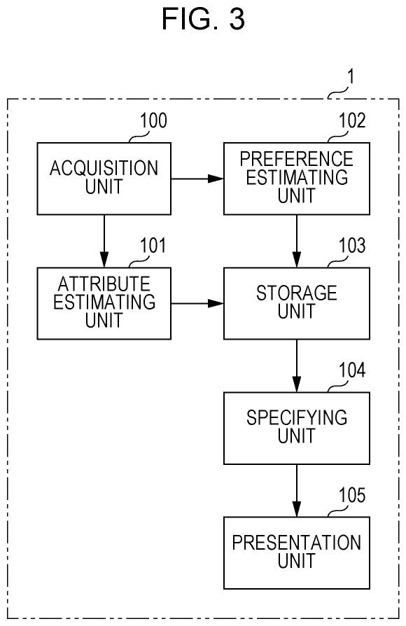

FIG. 3 is a block diagram illustrating the functional configuration of the information processing apparatus 1. An acquisition unit 100 acquires posting histories via the network 3 from the posting sites 2.

An attribute estimating unit 101 estimates, from posting histories of multiple SNS users, the attribute of each SNS user. Specifically, the attribute estimating unit 101 performs machine learning in advance, for example, on the relationship between text data, which is included in the posts, and the attribute of the SNS user by using a technique such as supervised learning. For example, when words which are used by females in their 20s occur in posts frequently, the attribute estimating unit 101 has learnt the relationship where the SNS user who has written the posts is a female in her 20s. For each post, the attribute estimating unit 101 uses the learning model to estimate the attribute of the SNS user who has written the post. Herein, the attribute of an SNS user indicates, for example, their gender, age (or generation), occupation, or place of residence.

A preference estimating unit 102 estimates, from the posting histories of multiple SNS users, the preference of each SNS user. Specifically, for example, the preference estimating unit 102 uses a method such as a technique (sentiment analysis) of analyzing emotions of an SNS user about an item through natural language processing, so as to estimate the degree of the preference, for the item included in each post, of the SNS user who has written the post. That is, posts, on which the preference estimating unit 102 is to estimate preference, are limited to posts including words indicating an item.

A storage unit 103 stores the estimated attribute and preference in association with each other. For example, the storage unit 103 processes statistically all posts in terms of the relationship between attribute (for example, a female in her 20s) and preference (for example, the type of a product, the name of a place which may be a candidate of travel, and a cigarette brand) which are estimated for each post. Then, the storage unit 103 stores the result. For example, as a result of the processing on each SNS user, “attribute: 20s”, “gender: female”, “item: Hawaii”, “preference: positive”, and the like are stored.

A specifying unit 104 specifies the preference corresponding to the attribute of a customer-user, to whom an item is to be recommended, from the information stored in the storage unit 103. Specifically, the specifying unit 104 specifies the attribute of a customer-user, to whom an item is to be recommended, from a customer list or the like including at least user identification information and its customer-user's attribute. The specifying unit 104 further specifies the preference corresponding to the attribute of the customer-user from the information stored in the storage unit 103. For example, if the attribute of a customer-user who is a recommendation target is “female in their 20s”, information indicating “item: Hawaii” and “preference: positive” is specified as an item and the preference corresponding to the item.

A presentation unit 105 presents an item corresponding to the specified preference to the customer-user who is to be a recommendation target. Specifically, the presentation unit 105 transmits, for display, information about the item to a communication apparatus or the like of the user identified by the user identification information. The information about an item indicates an item corresponding to the preference specified by the specifying unit 104 from an item list or the like which includes at least the type of the preference of the SNS user and information about an item matching the preference (such as the item name and description about the item). For example, when the preference of an SNS user, who is a female in her 20s, is “positive” for “Hawaii” and a list for travel destinations is given as an item, if an item name included in the list is “Hawaii”, the item is transmitted to the communication apparatus or the like of the customer-user as a recommendation item.

### Operations

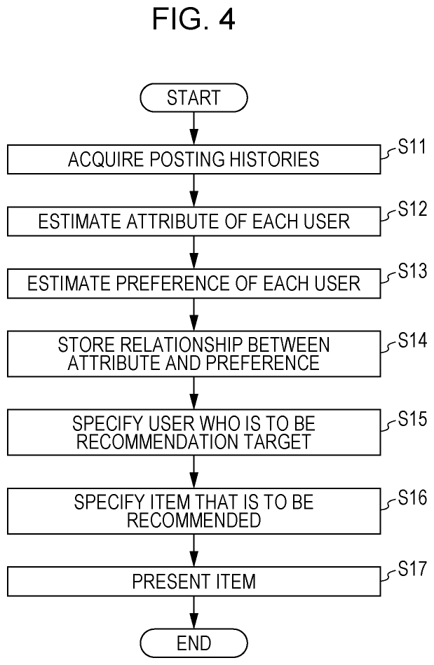

FIG. 4 is a flowchart of operations performed by the information processing apparatus 1. The acquisition unit 100 acquires multiple posting histories from the posting sites 2 over the network 3 (step S11).

The attribute estimating unit 101 estimates, from the posting histories of multiple SNS users, the attribute of each SNS user (step S12).

The preference estimating unit 102 estimates, from the posting histories of multiple SNS users, the preference a each SNS user (step S13).

The storage unit 103 stores the estimated attribute and preference in association with each other (step S14).

The specifying unit 104 specifies a customer-user, to whom an item is to be recommended, for example, in the customer list (step S15).

The specifying unit 104 specifies, from the information stored in the storage unit 103, the preference corresponding to the attribute of the SNS user specified as a recommendation target (step S16).

The presentation unit 105 presents, to the SNS user that is to be a recommendation target, the item corresponding to their specified preference (step S17).

According to the exemplary embodiment described above, the relationship between the attribute of each SNS user and their preference is estimated from multiple posting histories. The estimation result is used to present an item corresponding to the preference of a specified customer-user.

### MODIFIED EXAMPLE

The modified examples described below may be combined together for implementation.

### First Modified Example

When the preference estimating unit 102 estimates, from a posting history satisfying a given condition, the preference of the SNS user, the preference estimating unit 102 may perform weighting on the relationship between posting history and preference, and may estimate the preference of the SNS user. Weighting examples which may be employed are as follows.

For example, in the case where the condition that an author who has written a post is not the original author of the post is satisfied, the preference estimating unit 102 may cause a weight on such a relationship between posting history and preference to be smaller than a weight for the case in which the author who has written a post is the original author of the post. For example, a post, called tweeting, of a first SNS user who is to be a recommendation target may be transcribed and written by a second SNS user in the format called retweeting. In this case, the preference of the second SNS user nay not be expressed in the information posted by the second SNS user. Therefore, weight on the relationship between the posting history of the second SNS user and the preference of the second SNS user is made small. Examples of a method of making a weight small may include a method of multiplying the number of posts, which obtained in summarization in a statistical process, by a value less than one, a method of multiplying a score conversion result of positive/negative in sentiment analysis by a value less than one, and a method of performing downsampling on training data. This weakens the relationship between attribute and preference when the storage unit 103 stores, in association with each other, the attribute estimated by the attribute estimating unit 101 and the preference estimated by the preference estimating unit 102.

In addition, for example, when a post satisfies the condition that the post aims at advertisement, the preference estimating unit 102 may cause a weight on the relationship between posting history and preference to be smaller than a weight on a post aiming at a purpose other than advertisement. Also in this case, this is because the preference of an SNS user, who is an author, may not be expressed in the information of a post aiming advertisement. Examples of a method of making a weight small are similar to those described above.

### Second Modified Example

The relationship between the attribute of an SNS user and the preference of the SNS user may change depending on the attribute of the SNS user. For example, the degree in which the attribute of occupation relates to the preference may be smaller than the degree in which the attribute of gender relates to the preference. Thus, if the preference estimating unit 102 assumes that the weight on the preference corresponding to a certain attribute is equal to one, the preference estimating unit 102 sets a weight on the preference corresponding to the other attributes to a value less than one. That is, in accordance with the attribute of an SNS user estimated by the attribute estimating unit 101, the preference estimating unit 102 changes the weight on the relationship between the posting history and the preference of the SNS user. More specifically, in accordance with the type of the attribute of an SNS user estimated by the attribute estimating unit 101, the preference estimating unit 102 changes the weight on the relationship between the posting history and the preference of the SNS user.

The estimation accuracy, with which the attribute estimating unit 101 estimates the attribute of an SNS user, may change depending on the attribute. For example, the accuracy with which the attribute estimating unit 101 estimates the attribute of age (or generation) may be higher than the accuracy with which the attribute estimating unit 101 estimates the attribute of occupation. When the age and occupation of a customer-user who is to be a recommendation target are estimated as attributes of the customer-user, if the preference estimating unit 102 assumes that a weight on the preference corresponding to the attribute of age is equal to one, the preference estimating unit 102 sets a weight on the preference corresponding to the attribute of occupation to a value less than one. That is, the preference estimating unit 102 changes the weight on the relationship between the posting history and the preference of an SNS user in accordance with an attribute of the SNS user estimated by the attribute estimating unit 101. More specifically, the preference estimating unit 102 changes the weight on the relationship between the posting history and the preference of the SNS user in accordance with the estimation accuracy of an attribute of the SNS user estimated by the attribute estimating unit 101.

As described above, the attribute estimating unit 101 may estimate an attribute erroneously. Therefore, the preference estimating unit 102 may change the weight on the relationship between the posting history and the preference of the SNS user by taking into account attributes other than the estimated attribute. For example, if the estimation accuracy with which the attribute of the SNS user is estimated as a student is 70%, the remaining probability of 30% (=100−70) is distributed evenly to the other attributes (for example, assume that the attributes are those of office worker, housewife, and individual proprietor). Thus, 10% is assigned to the attribute of office worker; 10% is assigned to the attribute of housewife; 10% is assigned to the attribute of individual proprietor. That is, the preference estimating unit 102 assumes that the recommendation target is a student with a probability of 70%, is an office worker with a probability of 10%, is a housewife with a probability of 10%, and is an individual proprietor with a probability of 10%. Under this assumption, the preference estimating unit 102 estimates their preference.

If the probability of erroneous estimation is known, the preference estimating unit 102 may change the weight on the relationship between the posting history and the preference of the SNS user by taking into account the probability with which their attribute is other than the estimated attribute. For example, assume that the estimation accuracy of having the attribute of student is 70%; office worker, 15%; housewife, 10%; and individual proprietor, 5%. In this case, the specifying unit 104 assumes that the recommendation target is a student with a probability of 70%, is an office worker with a probability of 15%, is a housewife with a probability of 10%, and is an individual proprietor with a probability of 5%. Under this assumption, the specifying unit 104 estimates their preference.

### Third Modified Example

An attribute, which is present in the customer list which lists customer-users who may be recommendation targets, may not be included in the attributes estimated from the posting sites. For example, this case is such that there is an attribute of 40s in the customer list, but the attributes of users which are estimated from the posting histories regarding a certain item are only 10s, 20s, and 30s. Thus, when the same attribute as the attribute of the customer-user who is a recommendation target is not stored in the storage unit 103, the specifying unit 104 may specify the preference of the customer-user, who is to be a recommendation target, by using the preference of users having another attribute of the recommendation target. For example, the specifying unit 104 specifies the preference of a recommendation target in accordance with the preference of a customer-user whose attribute does not match a first attribute among the attribute of the customer-user who is a recommendation target but matches a second attribute. For example, if the storage unit 103 does not store an attribute of a housewife in their 40s, which is an attribute of the recommendation target, but stores an attribute of housewife in their 20s and an attribute of housewife in their 30s, the specifying unit 104 specifies the preference, which is obtained by averaging the preference corresponding to the attribute of housewife in their 20s and the preference corresponding to the attribute of housewife in their 30s, for an item that is to be recommended to a user who has an attribute of housewife in their 40s and who is a recommendation target. In this case, the first attribute described above is “40s”, and the second attribute is “housewife”.

The specifying unit 104 may specify the preference of a customer-user, who is to be a recommendation target and who has a first attribute, in accordance with the preference of customer-users having a second attribute and having preference similar to the preference of the first customer-user. For example, under the assumption that the preference of a user in their 40s is close to the preference of a user in their 30s, the specifying unit 104 specifies the preference of a customer-user, who has the attribute of housewife in their 40s and is a recommendation target, on the basis of the preference corresponding to the attribute of housewife in their 30s.

Examples of a method of determining which attribute a customer-user, who has preference similar to the preference of a user who is to be a recommendation target, has are as follows. The first case is that the attribute is determined in advance on the basis of prior knowledge. For example, the preference for a certain fashion is closer between housewives and individual proprietors than between housewives and office workers. That is, the attribute of a customer-user having preference similar to the preference of a customer-user who is to be a recommendation target is determined in advance.

Another method is such that the value of an attribute in a coordinate space is determined on the basis of closeness in position. For example, an attribute of place of residence is closer between the Kanto region and the Tokai region than between the Kanto region and the Kansai region. As another example, the attribute of age is closer between 40s and 30s than between 40s and 20s. That is, the attribute of a customer-user having preference similar to the preference of a customer-user who is to be a recommendation target is determined in accordance with closeness in the value or position of the attribute.

As another method is such that the preference is determined on the basis of the preference for an item. For example, there are no posts of SNS users in their 40s regarding the item A. However, the preference of SNS users in their 40s regarding the item B and the item C is close to the preference of SNS users in their 30s. Therefore, the preference of SNS users in their 40s regarding the item A is specified on the basis of the preference of SNS users in their 30s. That is, the preference, for a first item, of an SNS user, who is to be a recommendation target, is determined in accordance with the preference of another user regarding a second item.

The present disclosure may be also provided through a program for causing a computer to function as the information processing apparatus or through a recording medium in which the program has been recorded. The program provided by the present disclosure may be downloaded to a computer over a network such as the Internet.

The information processing apparatus provided by the present disclosure may be included in an image forming apparatus.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
an attribute estimating unit that estimates, from posting histories of a plurality of users, an attribute of each of the plurality of users;
a preference estimating unit that estimates, from the posting histories of the plurality of users, preference of each of the plurality of users;
a storage unit that stores the estimated attribute and preference in association with each other;
a specifying unit that specifies the preference corresponding to an attribute of a user who is to be a recommendation target, the preference being specified from information stored in the storage unit; and
a presentation unit that presents, to the user who is to be a recommendation target, an item in accordance the preference specified for the user who is to be a recommendation target.

2. The information processing apparatus according to claim 1,
wherein, when the preference estimating unit is to estimate preference from a posting history matching a given condition, the preference estimating unit performs weighting on a relationship between the posting history and the preference and estimates the preference of the user.

3. The information processing apparatus according to claim 2,
wherein, when a user who has written a post is not an original author of the Posting history, the preference estimating unit causes a weight on the relationship between the posting history and the preference to be smaller than a weight for a case in which the user who has written the post is the original author of the posting history.

4. The information processing apparatus according to claim 2,
wherein, for a posting history whose aim is advertisement, the preference estimating unit causes a weight on the relationship between the posting history and the preference to be smaller than a weight on a post whose aim is other than advertisement.

5. The information processing apparatus according to claim 1,
wherein the preference estimating unit changes a weight on a relationship between the posting history and the preference of a user in accordance with the attribute of the user estimated by the attribute estimating unit.

6. The information, processing apparatus according to claim 5,
wherein the preference estimating unit changes the weight on the relationship between the posting tory and the preference of the user in accordance with a type of the attribute of the user estimated by the attribute estimating unit.

7. The information processing apparatus according to claim 5,
wherein the preference estimating unit changes the weight on the relationship between the posting history and the preference of the user in accordance with estimation accuracy of the attribute of the user estimated by the attribute estimating unit.

8. The information processing apparatus according to claim 7,
wherein the preference estimating unit changes the weight on the relationship between the posting history and the preference of the user by taking into account an attribute other than the attribute of the user who is to be a recommendation target.

9. The information processing apparatus according to claim 7,
wherein the preference estimating unit changes the weight on the relationship between the posting history and the preference of the user by taking into account a probability of having an attribute other than the attribute estimated by the attribute estimating unit.

10. The information processing apparatus according to claim 1,
wherein, when the storage unit does not store an attribute identical to the attribute of the user who is to be a recommendation target, the specifying unit specifies the preference of the user who is to be a recommendation target, by using the preference of a user having another attribute.

11. The information processing apparatus according to claim 10,
wherein, when the storage unit does not store a first attribute identical to the attribute of the user who is to be a recommendation target, the specifying unit specifies the preference corresponding to a second attribute included in the attribute of the user who is to be a recommendation target.

12. The information processing apparatus according to claim 10,
wherein, when the storage unit does not store an attribute identical to a first attribute of the user who is to be a recommendation target, the specifying unit specifies the preference corresponding to a second attribute identical to the attribute of the user who is to be a recommendation. target, the preference being specified in accordance with the preference of a user having the second attribute and having preference similar to the preference of the user who is to be a recommendation target.

13. The information processing apparatus according to claim 12,
wherein the attribute of the user who has preference similar to the preference of the user who is to be a recommendation target is determined in advance.

14. The information processing apparatus according to claim 12,
wherein the attribute of the user who has preference similar to the preference of the user who is to be a recommendation target is determined in accordance with closeness in value or position of the attribute.

15. The information processing apparatus according to claim 12,
wherein the preference, for a first item, of the user who is to be a recommendation target is determined in accordance with the preference of another user for a second item.

16. An information processing apparatus comprising:
means for estimating, from posting histories of a plurality of users, an attribute of each of the plurality of users;
means for estimating, from the posting histories of the plurality of users, preference of each of the plurality of users;
means for storing the estimated attribute and preference in association with each other;
means for specifying the preference corresponding to an attribute of a user who is to a recommendation target, the preference being specified from information stored in the storage unit; and
means for presenting, to the user who is to be a recommendation target, an item in accordance with the preference specified for the user who is to be a recommendation target.
